(19) United States
(12) Patent Application Publication
(10) Pub. No.: US 2026/0335860 A1
(43) Pub. Date: Oct. 29, 2026

(54) SORBENT MATERIALS FOR IN SITU GAS PURIFICATION AND STORAGE

(71) Applicant: Entegris, Inc., Billerica, MA (US)

(72) Inventors: Paolo Moreschini, Newtown, CT (US); Kaitlin Jeanne Lawrence, Brookfield, CT (US); Alemayehu Hailu Bedane, Watertown, CT (US)

(21) Appl. No.: 19/653,683

(22) Filed: Apr. 21, 2026

Related U.S. Application Data
(60) Provisional application No. 63/795,223, filed on Apr. 25, 2025.

(51) Int. Cl. B01J 20/20; B01D 53/04; B01J 20/04; B01J 20/28; B01J 20/34

(52) U.S. Cl. CPC B01J 20/20; B01D 53/0415; B01J 20/046; B01J 20/28016; B01J 20/3416; B01J 20/3491; B01D 2253/102; B01D 2253/112; B01D 2256/26; B01D 2257/204; B01D 2259/40083

(57) ABSTRACT

Sorbent materials are provided herein. A sorbent material comprises a first sorbent component for sorbing and desorbing a process gas and a second sorbent component for selectively sorbing an impurity. When contained in a gas storage vessel under operating conditions, the sorbent material sorbs a first vapor comprising the process gas and up to 5% by volume of the impurity based on a total volume of the first vapor and desorbs a second vapor comprising the process gas and less than 1% by volume of the impurity based on a total volume of the second vapor. Gas storage vessels containing the sorbent material and related assemblies and related methods are also provided herein.

### CROSS-REFERENCE TO RELATED APPLICATION

This application claims the benefit of and priority to U.S. Provisional Application No. 63/795,223, filed Apr. 25, 2025, the entire disclosure of which is incorporated herein by reference in its entirety.

### TECHNICAL FIELD

The present disclosure relates to sorbent materials for gas storage and in situ gas purification, related assemblies, and related methods.

### BACKGROUND

Semiconductor manufacturing processes use high purity gases, including fluoride gases and hydride gases, as process gases for deposition, etching, ion implantation, and other fabrication steps. As device geometries shrink and process tolerances tighten, the purity requirements for these process gases continue to increase. Even trace levels of impurities in a delivered process gas can cause defects, yield loss, or process variation in semiconductor fabrication.

Common impurities in process gases include, for example, hydrogen fluoride (HF), water, hydrogen, hydrolysis products, counter-dopants, volatile metals, atmospheric contaminants, and particulates. The specific impurities of concern vary depending on the process gas. For example, fluoride process gases such as germanium tetrafluoride (GeF₄), boron trifluoride (BF₃), silicon tetrafluoride (SiF₄), phosphorus trifluoride (PF₃), and phosphorus pentafluoride (PF₅) are susceptible to HF contamination arising from hydrolysis in the presence of trace moisture. Hydride process gases such as phosphine (PH₃), arsine (AsH₃), and germane (GeH₄) can contain hydrogen, metal species from decomposition, and iron carbonyls.

### SUMMARY

The present disclosure relates to sorbent materials for gas storage and in situ gas purification, related assemblies, and related methods.

In some embodiments, an assembly comprises a vessel and a sorbent material contained in an interior volume of the vessel. The sorbent material comprises a first sorbent component for sorbing and desorbing a process gas and a second sorbent component for selectively sorbing an impurity. Under operating conditions, the sorbent material sorbs a first vapor comprising the process gas and up to 5% by volume of the impurity based on a total volume of the first vapor and desorbs a second vapor comprising the process gas and less than 1% by volume of the impurity based on a total volume of the second vapor.

In some embodiments, a sorbent material comprises a first sorbent component for sorbing and desorbing a process gas and a second sorbent component for selectively sorbing an impurity. When contained in a gas storage vessel under operating conditions, the sorbent material sorbs a first vapor comprising the process gas and up to 5% by volume of the impurity based on a total volume of the first vapor and desorbs a second vapor comprising the process gas and less than 1% by volume of the impurity based on a total volume of the second vapor.

In some embodiments, a method comprises delivering a first vapor comprising a process gas and up to 5% by volume of an impurity based on a total volume of the first vapor to a gas storage vessel. The gas storage vessel comprises a sorbent material. The sorbent material comprises a first sorbent component for sorbing and desorbing the process gas and a second sorbent component for selectively sorbing the impurity. Under operating conditions, the sorbent material is configured to desorb a second vapor comprising the process gas and less than 1% by volume of the impurity based on a total volume of the second vapor.

In some embodiments, a method comprises delivering a vapor from a vessel containing a sorbent material. The vapor comprises a process gas and up to 5% by volume of an impurity based on a total volume of the process gas and the impurity. Under operating conditions, the sorbent material desorbs the vapor comprising the process gas and less than 1% by volume of the impurity based on a total volume of the vapor.

### BRIEF DESCRIPTION OF THE DRAWINGS

The accompanying drawings are not intended to be drawn to scale. Like reference numerals and designations in the various drawings indicate like elements. For purposes of clarity, not every element may be labeled in every drawing.

FIG. 1 is a schematic drawing of a gas storage vessel showing a first sorbent component and a second sorbent component, according to some embodiments.

FIG. 2A is a schematic cross‑sectional view of a gas storage vessel containing a plurality of sorbent particles disposed within an interior volume of the vessel body, according to some embodiments.

FIG. 2B is a schematic cross‑sectional view of a gas storage vessel containing a plurality of sorbent pucks arranged in a stacked configuration within the vessel body, according to some embodiments.

FIG. 2C is a schematic cross‑sectional view of a gas storage vessel containing a plurality of monolithic, sorbent pucks provided in combination with a plurality of sorbent particles, according to some embodiments.

FIG. 2D is a schematic cross‑sectional view of a gas storage vessel containing a mixture of first and second sorbent particles distributed throughout the vessel body, according to some embodiments.

FIG. 3 is a system-level schematic diagram of a gas storage and delivery system, according to some embodiments.

FIG. 4 is a flowchart of a method for delivering a purified gas, according to some embodiments.

FIG. 5 shows Fourier transform infrared (FTIR) spectra comparing an HF impurity peak in a source gas, a gas desorbed from an unmodified sorbent material, and a gas desorbed from a modified sorbent material, according to some embodiments.

### DETAILED DESCRIPTION

The following detailed description is to be read with reference to the drawings, which are not drawn to scale and are not intended to limit the scope of the present disclosure. The description is provided to enable a person of ordinary skill in the art to make and use the embodiments disclosed herein, and various modifications to the disclosed embodiments will be apparent to those of ordinary skill. The detailed description is not intended to be an exhaustive description of all possible embodiments.

As used herein, the terms "comprises," "comprising," and variations thereof are to be construed as open-ended transitional phrases that do not exclude additional, unrecited elements or method steps. The terms "consisting of" and "consisting essentially of" are to be given their ordinary meaning as recognized in patent claim practice.

As used herein, the phrase "at least one of A, B, or C" is to be construed to mean a logical (A OR B OR C), using a non-exclusive logical OR, and is not to be construed to mean "at least one of A, at least one of B, and at least one of C."

All numerical ranges disclosed herein include and support all values and subranges within the disclosed range. For example, a disclosure of a range of 1 to 10 includes every value between 1 and 10 (e.g., 1, 1.5, 2.3, 7, 9.9) and every subrange within that range (e.g., 1 to 5, 3.2 to 8, 4 to 10). Any range of values described herein is inclusive of the endpoints unless otherwise stated.

As used herein, the terms "about" and "approximately," when modifying a numerical value, mean within a range of ±10% of the stated value, unless the context or specific statement indicates otherwise.

Some gas storage and delivery systems store process gases at sub-atmospheric pressures using sorbent materials, such as pyrolyzed carbon, contained within a gas storage vessel. In these systems, the process gas is sorbed onto the sorbent material during charging and desorbed from the sorbent material during delivery to a process tool. Sub-atmospheric storage reduces the risks associated with high-pressure containment of toxic and corrosive gases.

In conventional practice, the purity of a process gas is measured after it is charged into a gas storage vessel. If the measured impurity level exceeds a specification limit, the gas is released from the vessel and directed through an external purification process to remove impurities. After purification, the gas is returned to the vessel for storage. This purification loop introduces additional process time, increases the risk of material loss, and adds cost to the gas fill operation. In some cases, there is large variability in impurity levels across production lots, requiring repeated purification cycles before the gas meets the target specification.

Various gas purification techniques exist, including adsorbent beds, valve-integrated purifier assemblies, and membrane-based systems. However, these approaches generally treat gas purification and gas storage as separate operations, requiring dedicated purification equipment external to the gas storage vessel. Integrating purification directly into a sub-atmospheric gas storage vessel containing a sorbent material for reactive semiconductor process gases remains a challenge.

The sorbent materials, as described herein, can reduce or eliminate the external purification loop described above by providing in situ purification whereby the sorbent materials not only sorb and desorb the gas, they also sorb the impurities and do not desorb the impurities when desorbing the gas, thereby delivering a higher purity gas from the vessel.

To achieve this in situ purification, the sorbent material comprises at least two functional components: a first sorbent component that sorbs and desorbs a process gas, and a second sorbent component that selectively sorbs an impurity and retains the impurity during desorption of the process gas. The first and second sorbent components may be provided as separate materials within the gas storage vessel, or the first sorbent component may be modified with the second sorbent component to form a unitary sorbent material, as described in further detail below.

In some embodiments, the sorbent material is utilized in gas storage devices. In some embodiments, the gas storage devices store and deliver gases at sub-atmospheric pressures.

In some embodiments, the sorbent material comprises a first sorbent component for selectively sorbing and desorbing a process gas. In some embodiments, the sorbent material comprises a second sorbent component for selectively sorbing an impurity. In some embodiments, when contained in a gas storage vessel under operating conditions, the sorbent material sorbs a first vapor comprising a process gas and no greater than 5% by volume of the impurity based on a total volume of the first vapor. In some embodiments, when contained in a gas storage vessel under operating conditions, the sorbent material desorbs a second vapor comprising the process gas and less than 1% by volume of the impurity based on a total volume of the second vapor.

In some embodiments, when contained in a gas storage vessel under operating conditions, the sorbent material sorbs a first vapor comprising a process gas and 0.1% to 5%, or any range or subrange between 0.1% to 5%, by volume of the impurity based on a total volume of the first vapor. For example, in some embodiments, when contained in a gas storage vessel under operating conditions, the sorbent material sorbs a first vapor comprising a process gas and 0.1% to 4.5%, 0.1% to 4%, 0.1% to 3.5%, 0.1% to 3%, 0.1% to 2.5%, 0.1% to 2%, 0.1% to 1.5%, 0.1% to 1%, 0.1% to 0.5%, 0.5% to 5%, 1% to 5%, 1.5% to 5%, 2% to 5%, 2.5% to 5%, 3% to 5%, 3.5% to 5%, 4% to 5%, or 4.5% to 5% by volume of the impurity based on a total volume of the first vapor.

In some embodiments, when contained in a gas storage vessel under operating conditions, the sorbent material desorbs a second vapor comprising the process gas and less than 1.0%, less than 0.9%, less than 0.8%, less than 0.7%, less than 0.6%, less than 0.5%, less than 0.4%, less than 0.3%, less than 0.2%, less than 0.1%, less than 0.09%, less than 0.08%, less than 0.07%, less than 0.06%, less than 0.05%, less than 0.04%, less than 0.03%, less than 0.02%, or less than 0.01% by volume of the impurity based on the total volume of the second vapor.

In some embodiments, when contained in a gas storage vessel under operating conditions, the sorbent material desorbs a second vapor comprising the process gas and 0.001% to less than 1%, or any range or subrange between 0.001% to less than 1%, by volume of the impurity based on the total volume of the second vapor. For example, in some embodiments, when contained in a gas storage vessel under operating conditions, the sorbent material desorbs a second vapor comprising the process gas and 0.001% to 0.9%, 0.001% to 0.8%, 0.001% to 0.7%, 0.001% to 0.6%, 0.001% to 0.5%, 0.001% to 0.4%, 0.001% to 0.3%, 0.001% to 0.2%, 0.001% to 0.1%, 0.001% to 0.09%, 0.001% to 0.08%, 0.001% to 0.07%, 0.001% to 0.06%, 0.001% to 0.05%, 0.001% to 0.04%, 0.001% to 0.03%, 0.001% to 0.02%, 0.001% to 0.01%, 0.001% to 0.009%, 0.001% to 0.008%, 0.001% to 0.007%, 0.001% to 0.006%, 0.001% to 0.005%, 0.001% to 0.004%, 0.001% to 0.003%, 0.001% to 0.002%, 0.002% to less than 1%, 0.003% to less than 1%, 0.004% to less than 1%, 0.005% to less than 1%, 0.006% to less than 1%, 0.007% to less than 1%, 0.008% to less than 1%, 0.009% to less than 1%, 0.01% to less than 1%, 0.02% to less than 1%, 0.03% to less than 1%, 0.04% to less than 1%, 0.05% to less than 1%, 0.06% to less than 1%, 0.07% to less than 1%, 0.08% to less than 1%, 0.09% to less than 1%, 0.1% to less than 1%, 0.2% to less than 1%, 0.3% to less than 1%, 0.4% to less than 1%, 0.5% to less than 1%, 0.6% to less than 1%, 0.7% to less than 1%, 0.8% to less than 1%, or 0.9% to less than 1% by volume of the impurity based on the total volume of the second vapor. In some embodiments, the second vapor does not comprise any impurity.

In some embodiments, the second vapor comprises at least 10% less of the impurity than the first vapor. For example, in some embodiments, the second vapor comprises at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or at least 95% less of the impurity than the first vapor.

In some embodiments, the second vapor comprises 10% to 100%, or any range or subrange between 10% to 100%, less of the impurity than the first vapor. For example, in some embodiments, the second vapor comprises 10% to 95%, 10% to 85%, 10% to 80%, 10% to 75%, 10% to 70%, 10% to 65%, 10% to 60%, 10% to 55%, 10% to 50%, 10% to 45%, 10% to 40%, 10% to 35%, 10% to 30%, 10% to 25%, 10% to 20%, 10% to 15%, 15% to 100%, 20% to 100%, 25% to 100%, 30% to 100%, 35% to 100%, 40% to 100%, 45% to 100%, 50% to 100%, 55% to 100%, 60% to 100%, 65% to 100%, 70% to 100%, 75% to 100%, 80% to 100%, 85% to 100%, 90% to 100%, or 95% to 100% less of the impurity than the first vapor.

In some embodiments, the process gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorus pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydride, a halide compound, an organometallic compound, or any combination thereof.

In some embodiments, the impurity comprises at least one of a volatile metal, a counter-dopant, e.g., phosphorus impurities in boron, atmospheric impurities, particulates, hydrogen fluoride (HF), hydrolysis products, e.g., POF₃ or fluorogermanic acid, undesired fluoride products, silicon tetrafluoride (SiF₄), water, hydrogen (H₂), iron carbonyls, argon, sulfur dioxide (SO₂), siloxanes, nitrogen (N₂), oxygen (O₂), carbon monoxide, carbon dioxide, cyclopentanepentone (C₅O₅), methane (CH₄), or any combination thereof.

In some embodiments, the first sorbent component comprises at least one of a pyrolyzed carbon, an activated pyrolyzed carbon, or any combination thereof. In some embodiments, the pyrolyzed carbon, the activated pyrolyzed carbon, or any combination thereof comprises at least one polymer. In some embodiments, the at least one polymer comprises at least one of a homopolymer, a copolymer, or any combination thereof. In some embodiments, the at least one polymer comprises at least one of a polyvinylidene chloride (PVDC), a polyvinylidene fluoride (PVDF), a polytetrafluoroethylene (PTFE), a poly(ethene-co-tetrafluoroethene), a polymer from the polyaryletherketone family such as, for example, polyether ether ketone (PEEK), styrenics, petroleum pitch, cellulose, polyacrylonitrile, acrylates, phenolic resins, or any combination thereof.

In some embodiments, the first sorbent component is useful for sorbing and desorbing the process gas. In some embodiments, the first sorbent component comprises a porous sorbent component. In some embodiments, the first sorbent component has a porosity of at least 40%. For example, in some embodiments, the first sorbent component has a porosity of at least 45%, at least 50%, at least 55%, at least 60%, at least 65%, at least 70%, at least 75%, at least 80%, at least 85%, or at least 90%. In some embodiments, the first sorbent component has a porosity of 40% to 90%, or any range or subrange between 40% to 90%. For example, in some embodiments, the first sorbent component has a porosity of 40% to 85%, 40% to 80%, 40% to 75%, 40% to 70%, 40% to 65%, 40% to 60%, 40% to 55%, 40% to 50%, 40% to 45%, 45% to 90%, 50% to 90%, 55% to 90%, 60% to 90%, 65% to 90%, 70% to 90%, 75% to 90%, 80% to 90%, or 85% to 90%.

In some embodiments, the first sorbent component has a density of 0.5 g/cm³ to 2.5 g/cm³, or any range or subrange between 0.5 g/cm³ to 2.5 g/cm³. For example, in some embodiments, the first sorbent component has a density of 0.5 g/cm³ to 2.4 g/cm³, 0.5 g/cm³ to 2.3 g/cm³, 0.5 g/cm³ to 2.2 g/cm³, 0.5 g/cm³ to 2.1 g/cm³, 0.5 g/cm³ to 2 g/cm³, 0.5 g/cm³ to 1.9 g/cm³, 0.5 g/cm³ to 1.8 g/cm³, 0.5 g/cm³ to 1.7 g/cm³, 0.5 g/cm³ to 1.6 g/cm³, 0.5 g/cm³ to 1.5 g/cm³, 0.5 g/cm³ to 1.4 g/cm³, 0.5 g/cm³ to 1.3 g/cm³, 0.5 g/cm³ to 1.2 g/cm³, 0.5 g/cm³ to 1.1 g/cm³, 0.5 g/cm³ to 1.0 g/cm³, 0.5 g/cm³ to 0.9 g/cm³, 0.5 g/cm³ to 0.8 g/cm³, 0.5 g/cm³ to 0.7 g/cm³, 0.5 g/cm³ to 0.6 g/cm³, 0.6 g/cm³ to 2.5 g/cm³, 0.7 g/cm³ to 2.5 g/cm³, 0.8 g/cm³ to 2.5 g/cm³, 0.9 g/cm³ to 2.5 g/cm³, 1.0 g/cm³ to 2.5 g/cm³, 1.1 g/cm³ to 2.5 g/cm³, 1.2 g/cm³ to 2.5 g/cm³, 1.3 g/cm³ to 2.5 g/cm³, 1.4 g/cm³ to 2.5 g/cm³, 1.5 g/cm³ to 2.5 g/cm³, 1.6 g/cm³ to 2.5 g/cm³, 1.7 g/cm³ to 2.5 g/cm³, 1.8 g/cm³ to 2.5 g/cm³, 1.9 g/cm³ to 2.5 g/cm³, 2 g/cm³ to 2.5 g/cm³, 2.1 g/cm³ to 2.5 g/cm³, 2.2 g/cm³ to 2.5 g/cm³, 2.3 g/cm³ to 2.5 g/cm³, or 2.4 g/cm³ to 2.5 g/cm³.

In some embodiments, the first sorbent component can be a monolithic sorbent component. As used herein, the term “monolithic” refers to a single unitary piece. In some embodiments, the first sorbent component, when provided as a monolithic sorbent component, can be in the form of a puck, a brick, a cylinder, or a block. In some cases, the first sorbent component, when provided as a monolithic sorbent component, can comprise a plurality of pucks, bricks, cylinders, or blocks. For example, the monolithic sorbent component can include a plurality of pucks in a stacked configuration within the interior of the vessel. As used herein, the term “puck” refers to a disc-shaped monolithic body having a thickness that is less than its diameter.

In other embodiments, the first sorbent component can comprise a plurality of sorbent particles. The plurality of particles can have an average particle size of 1 nm to 1000 µm, or any range or subrange between 1 nm to 1000 µm. For example, in some embodiments, the plurality of particles has an average particle size of 1 nm to 900 µm, 1 nm to 800 µm, 1 nm to 700 µm, 1 nm to 600 µm, 1 nm to 500 µm, 1 nm to 400 µm, 1 nm to 300 µm, 1 nm to 200 µm, 1 nm to 100 µm, 1 nm to 50 µm, 1 nm to 10 µm, 1 nm to 5 µm, 1 nm to 1 µm, 1 nm to 900 nm, 1 nm to 800 nm, 1 nm to 700 nm, 1 nm to 600 nm, 1 nm to 500 nm, 1 nm to 400 nm, 1 nm to 300 nm, 1 nm to 200 nm, 1 nm to 100 nm, 1 nm to 50 nm, 1 nm to 10 nm, 10 nm to 1000 µm, 50 nm to 1000 µm, 100 nm to 1000 µm, 200 nm to 1000 µm, 300 nm to 1000 µm, 400 nm to 1000 µm, 500 nm to 1000 µm, 600 nm to 1000 µm, 700 nm to 1000 µm, 800 nm to 1000 µm, 900 nm to 1000 µm, 1 µm to 1000 µm, 5 µm to 1000 µm, 10 µm to 1000 µm, 50 µm to 1000 µm, 100 µm to 1000 µm, 200 µm to 1000 µm, 300 µm to 1000 µm, 400 µm to 1000 µm, 500 µm to 1000 µm, 600 µm to 1000 µm, 700 µm to 1000 µm, 800 µm to 1000 µm, or 900 µm to 1000 µm.

In some embodiments, the sorbent material comprises 40% to 99.999%, or any range or subrange between 40% to 99.999%, by weight of the first sorbent component based on a total weight of the sorbent material. For example, in some embodiments, the sorbent material comprises 40% to 99.998%, 40% to 99.997%, 40% to 99.996%, 40% to 99.995%, 40% to 99.994%, 40% to 99.993%, 40% to 99.992%, 40% to 99.991%, 40% to 99.99%, 40% to 99.98%, 40% to 99.97%, 40% to 99.96%, 40% to 99.95%, 40% to 99.94%, 40% to 99.93%, 40% to 99.92%, 40% to 99.91%, 40% to 99.9%, 40% to 99.8%, 40% to 99.7%, 40% to 99.6%, 40% to 99.5%, 40% to 99.4%, 40% to 99.3%, 40% to 99.2%, 40% to 99.1%, 40% to 99%, 40% to 98%, 40% to 97%, 40% to 96%, 40% to 95%, 40% to 94%, 40% to 93%, 40% to 92%, 40% to 91%, 40% to 90%, 40% to 89%, 40% to 88%, 40% to 87%, 40% to 86%, 40% to 85%, 40% to 84%, 40% to 83%, 40% to 82%, 40% to 81%, 40% to 80%, 40% to 79%, 40% to 78%, 40% to 77%, 40% to 76%, 40% to 75%, 40% to 74%, 40% to 73%, 40% to 72%, 40% to 71%, 40% to 70%, 40% to 69%, 40% to 68%, 40% to 67%, 40% to 66%, 40% to 65%, 40% to 64%, 40% to 63%, 40% to 62%, 40% to 61%, 40% to 60%, 40% to 59%, 40% to 58%, 40% to 57%, 40% to 56%, 40% to 55%, 40% to 54%, 40% to 53%, 40% to 52%, 40% to 51%, 40% to 50%, 40% to 49%, 40% to 48%, 40% to 47%, 40% to 46%, 40% to 45%, 40% to 44%, 40% to 43%, 40% to 42%, or 40% to 41% by weight of the first sorbent component based on a total weight of the sorbent material.

In some embodiments, the sorbent material comprises 41% to 99.999%, 42% to 99.999%, 43% to 99.999%, 44% to 99.999%, 45% to 99.999%, 46% to 99.999%, 47% to 99.999%, 48% to 99.999%, 49% to 99.999%, 50% to 99.999%, 51% to 99.999%, 52% to 99.999%, 53% to 99.999%, 54% to 99.999%, 55% to 99.999%, 56% to 99.999%, 57% to 99.999%, 58% to 99.999%, 59% to 99.999%, 60% to 99.999%, 61% to 99.999%, 62% to 99.999%, 63% to 99.999%, 64% to 99.999%, 65% to 99.999%, 66% to 99.999%, 67% to 99.999%, 68% to 99.999%, 69% to 99.999%, 70% to 99.999%, 71% to 99.999%, 72% to 99.999%, 73% to 99.999%, 74% to 99.999%, 75% to 99.999%, 76% to 99.999%, 77% to 99.999%, 78% to 99.999%, 79% to 99.999%, 80% to 99.999%, 81% to 99.999%, 82% to 99.999%, 83% to 99.999%, 84% to 99.999%, 85% to 99.999%, 86% to 99.999%, 87% to 99.999%, 88% to 99.999%, 89% to 99.999%, 90% to 99.999%, 91% to 99.999%, 92% to 99.999%, 93% to 99.999%, 94% to 99.999%, 95% to 99.999%, 96% to 99.999%, 97% to 99.999%, 98% to 99.999%, 99% to 99.999%, 99.1% to 99.999%, 99.2% to 99.999%, 99.3% to 99.999%, 99.4% to 99.999%, 99.5% to 99.999%, 99.6% to 99.999%, 99.7% to 99.999%, 99.8% to 99.999%, 99.9% to 99.999%, 99.91% to 99.999%, 99.92% to 99.999%, 99.93% to 99.999%, 99.94% to 99.999%, 99.95% to 99.999%, 99.96% to 99.999%, 99.97% to 99.999%, 99.98% to 99.999%, 99.99% to 99.999%, 99.991% to 99.999%, 99.992% to 99.999%, 99.993% to 99.999%, 99.994% to 99.999%, 99.995% to 99.999%, 99.996% to 99.999%, 99.997% to 99.999%, or 99.998% to 99.999% by weight of the first sorbent component based on the total weight of the sorbent material.

As introduced above, the sorbent material also includes a second sorbent component for selectively sorbing an impurity. Without being bound by theory, the selectivity of the second sorbent component for the impurity relative to the process gas arises from differences in intermolecular interactions between the gas-phase molecules and the second sorbent component. For example, in some embodiments, the impurity has a dipole moment and the process gas does not have a dipole moment, or the impurity has a larger dipole moment than the process gas. In such embodiments, dipole-dipole interactions between the impurity and the second sorbent component (e.g., a metal halide such as potassium fluoride) cause the impurity to sorb more strongly to the second sorbent component than the process gas. For example, hydrogen fluoride (HF) has a dipole moment, while germanium tetrafluoride (GeF₄) does not. When the second sorbent component comprises an alkali metal fluoride, HF interacts more strongly with the alkali metal fluoride through dipole-dipole interactions, resulting in selective sorption of HF relative to GeF₄. In some embodiments, the selective sorption of the impurity may additionally or alternatively arise from chemical interactions between the impurity and the second sorbent component, for example, formation of bifluoride species on the surface of the second sorbent component.

The second sorbent component can include at least one of an alkali metal, an alkaline earth metal, a transition metal, a molecular sieve, an alumina, a pyrolyzed carbon, an activated pyrolyzed carbon, or any combination thereof. The molecular sieve can include at least one of a zeolite, a mesoporous silica, an activated carbon, a metal-organic framework (MOF), a covalent organic framework (COF), or any combination thereof.

The second sorbent component can be different from the first sorbent component. In some embodiments, the second sorbent component does not appreciably sorb the process gas. For example, in some embodiments, if the second sorbent component sorbs the process gas, the amount sorbed by the second sorbent component is undetectable or negligible. In some embodiments, the first sorbent component does not appreciably sorb the impurity. For example, in some embodiments, if the first sorbent component sorbs the impurity, the amount sorbed by the first sorbent component is undetectable or negligible.

In some embodiments, the second sorbent component comprises a metal halide. In some embodiments, the second sorbent component comprises at least one of an alkali metal halide, an alkaline earth metal halide, or any combination thereof, for example and without limitation, a sodium fluoride, a potassium fluoride, a cesium fluoride, a magnesium fluoride, a calcium fluoride, or any combination thereof.

In some embodiments, the sorbent material comprises 0.001% to 60%, or any range or subrange between 0.001% to 60%, by weight of the second sorbent component based on the total weight of the sorbent material. For example, in some embodiments, the sorbent material comprises 0.001% to 59%, 0.001% to 58%, 0.001% to 57%, 0.001% to 56%, 0.001% to 55%, 0.001% to 54%, 0.001% to 53%, 0.001% to 52%, 0.001% to 51%, 0.001% to 50%, 0.001% to 49%, 0.001% to 48%, 0.001% to 47%, 0.001% to 46%, 0.001% to 45%, 0.001% to 44%, 0.001% to 43%, 0.001% to 42%, 0.001% to 41%, 0.001% to 40%, 0.001% to 39%, 0.001% to 38%, 0.001% to 37%, 0.001% to 36%, 0.001% to 35%, 0.001% to 34%, 0.001% to 33%, 0.001% to 32%, 0.001% to 31%, 0.001% to 30%, 0.001% to 29%, 0.001% to 28%, 0.001% to 27%, 0.001% to 26%, 0.001% to 25%, 0.001% to 24%, 0.001% to 23%, 0.001% to 22%, 0.001% to 21%, 0.001% to 20%, 0.001% to 19%, 0.001% to 18%, 0.001% to 17%, 0.001% to 16%, 0.001% to 15%, 0.001% to 14%, 0.001% to 13%, 0.001% to 12%, 0.001% to 11%, 0.001% to 10%, 0.001% to 9%, 0.001% to 8%, 0.001% to 7%, 0.001% to 6%, 0.001% to 5%, 0.001% to 4%, 0.001% to 3%, 0.001% to 2%, 0.001% to 1%, 0.001% to 0.9%, 0.001% to 0.8%, 0.001% to 0.7%, 0.001% to 0.6%, 0.001% to 0.5%, 0.001% to 0.4%, 0.001% to 0.3%, 0.001% to 0.2%, 0.001% to 0.1%, 0.001% to 0.09%, 0.001% to 0.08%, 0.001% to 0.07%, 0.001% to 0.06%, 0.001% to 0.05%, 0.001% to 0.04%, 0.001% to 0.03%, 0.001% to 0.02%, 0.001% to 0.01%, 0.001% to 0.009%, 0.001% to 0.008%, 0.001% to 0.007%, 0.001% to 0.006%, 0.001% to 0.005%, 0.001% to 0.004%, 0.001% to 0.003%, or 0.001% to 0.002% by weight of the second sorbent component based on the total weight of the sorbent material.

In some embodiments, the sorbent material comprises 0.002% to 60%, 0.003% to 60%, 0.004% to 60%, 0.005% to 60%, 0.006% to 60%, 0.007% to 60%, 0.008% to 60%, 0.009% to 60%, 0.01% to 60%, 0.02% to 60%, 0.03% to 60%, 0.04% to 60%, 0.05% to 60%, 0.06% to 60%, 0.07% to 60%, 0.08% to 60%, 0.09% to 60%, 0.1% to 60%, 0.2% to 60%, 0.3% to 60%, 0.4% to 60%, 0.5% to 60%, 0.6% to 60%, 0.7% to 60%, 0.8% to 60%, 0.9% to 60%, 1% to 60%, 2% to 60%, 3% to 60%, 4% to 60%, 5% to 60%, 6% to 60%, 7% to 60%, 8% to 60%, 9% to 60%, 10% to 60%, 11% to 60%, 12% to 60%, 13% to 60%, 14% to 60%, 15% to 60%, 16% to 60%, 17% to 60%, 18% to 60%, 19% to 60%, 20% to 60%, 21% to 60%, 22% to 60%, 23% to 60%, 24% to 60%, 25% to 60%, 26% to 60%, 27% to 60%, 28% to 60%, 29% to 60%, 30% to 60%, 31% to 60%, 32% to 60%, 33% to 60%, 34% to 60%, 35% to 60%, 36% to 60%, 37% to 60%, 38% to 60%, 39% to 60%, 40% to 60%, 41% to 60%, 42% to 60%, 43% to 60%, 44% to 60%, 45% to 60%, 46% to 60%, 47% to 60%, 48% to 60%, 49% to 60%, 50% to 60%, 51% to 60%, 52% to 60%, 53% to 60%, 54% to 60%, 55% to 60%, 56% to 60%, 57% to 60%, 58% to 60%, or 59% to 60% by weight of the second sorbent component based on the total weight of the sorbent material.

Like the first sorbent component, the second sorbent component can be a monolithic sorbent component provided in the form of a puck, a brick, a cylinder, a block or a plurality of particles. In some cases, the second sorbent component can comprise a plurality of pucks, bricks, cylinders, or blocks. When provided in particulate form, the second sorbent component can have an average particle size of 1 nm to 1000 µm, or any range or subrange between 1 nm to 1000 µm. For example, in some embodiments, the plurality of particles has an average particle size of 1 nm to 900 µm, 1 nm to 800 µm, 1 nm to 700 µm, 1 nm to 600 µm, 1 nm to 500 µm, 1 nm to 400 µm, 1 nm to 300 µm, 1 nm to 200 µm, 1 nm to 100 µm, 1 nm to 50 µm, 1 nm to 10 µm, 1 nm to 5 µm, 1 nm to 1 µm, 1 nm to 900 nm, 1 nm to 800 nm, 1 nm to 700 nm, 1 nm to 600 nm, 1 nm to 500 nm, 1 nm to 400 nm, 1 nm to 300 nm, 1 nm to 200 nm, 1 nm to 100 nm, 1 nm to 50 nm, 1 nm to 10 nm, 10 nm to 1000 µm, 50 nm to 1000 µm, 100 nm to 1000 µm, 200 nm to 1000 µm, 300 nm to 1000 µm, 400 nm to 1000 µm, 500 nm to 1000 µm, 600 nm to 1000 µm, 700 nm to 1000 µm, 800 nm to 1000 µm, 900 nm to 1000 µm, 1 µm to 1000 µm, 5 µm to 1000 µm, 10 µm to 1000 µm, 50 µm to 1000 µm, 100 µm to 1000 µm, 200 µm to 1000 µm, 300 µm to 1000 µm, 400 µm to 1000 µm, 500 µm to 1000 µm, 600 µm to 1000 µm, 700 µm to 1000 µm, 800 µm to 1000 µm, or 900 µm to 1000 µm.

In some embodiments, the second sorbent component can be mixed with the first sorbent component. For example, both the first and second sorbent components can be provided as a plurality of particles, as monolithic sorbent components, or a combination thereof.

In some embodiments, the first sorbent component can be modified with the second sorbent component. For example, in some embodiments, the first sorbent component can be functionalized, impregnated, doped, coated, infused, embedded, incorporated, combined, mixed, or any combination thereof, with the second sorbent component.

Some embodiments relate to an assembly comprising the sorbent material. In some embodiments, the assembly comprises a gas storage vessel configured to receive, contain, and release a gas.

In some embodiments, the sorbent material is contained in an interior volume of the gas storage vessel and comprises a first sorbent component for sorbing and desorbing a process gas and a second sorbent component for selectively sorbing an impurity. In some embodiments, the sorbent material comprises any one or more of the sorbent materials disclosed herein. In some embodiments, under operating conditions, the first and second sorbent components sorb a first vapor comprising the process gas and up to 5% by volume of the impurity based on a total volume of the first vapor and desorb a second vapor comprising the process gas and less than 1% by volume of the impurity, based on a total volume of the second vapor.

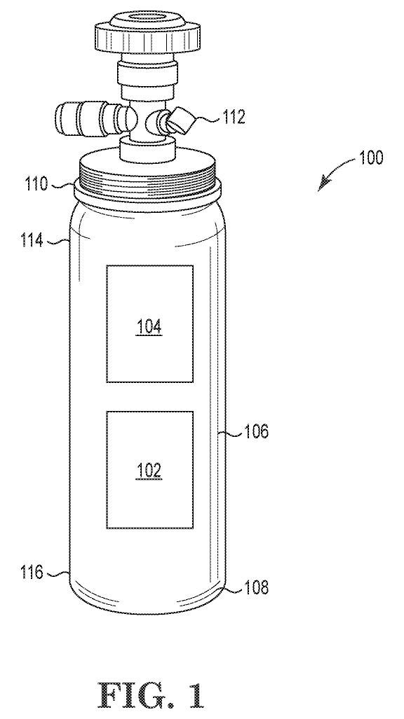

FIG. 1 is a schematic drawing of a gas storage vessel 100, according to some embodiments. In some embodiments, the gas storage vessel 100 is a cylindrical gas storage vessel comprising a sidewall 106 and a bottom wall 108 enclosing an interior volume. The gas storage vessel 100 may be formed of any suitable material of construction, for example, metals (such as steel, stainless steel, aluminum, copper, brass, bronze, and alloys thereof), glasses, ceramics, vitreous materials, polymers, composite materials, or any combination thereof.

The gas storage vessel 100 contains a sorbent material in its interior volume. As shown in FIG. 1, the sorbent material comprises a first sorbent component 102 and a second sorbent component 104. In some embodiments, as described herein, the sorbent material can be provided as a plurality of disc-shaped monolithic sorbent articles (pucks) stacked in face-to-face relationship along a longitudinal axis of the gas storage vessel 100 to form a vertically extended composite sorbent body. In other embodiments, the sorbent material comprises a first sorbent component 102 and a second sorbent component 104 provided in particulate form. In still other embodiments, the sorbent material comprises a combination of monolithic pucks and sorbent particles.

In some embodiments, the upper edges of the sidewall 106 are secured to a neck collar 110, for example, by welding, brazing, or other suitable securement technique. The neck collar 110 has a central opening with a threaded interior surface configured to threadably engage a valve assembly 112. In some embodiments, the valve assembly 112 comprises interior passages communicating with a dispense port for joining to external flow circuitry. In some embodiments, the valve assembly 112 comprises a valve actuator for opening and closing a valve disposed within the valve assembly 112. The valve actuator may comprise a manual actuator, such as a hand-wheel, or an automatic actuator, such as a solenoid actuator, pneumatic actuator, or the like. In some embodiments, a protective cap is threadably engaged with the neck collar 110 to protect the valve assembly 112 from impact and environmental exposure.

In some embodiments, the sorbent material comprises a plurality of pucks of the first sorbent component 102 and one or more pucks of the second sorbent component 104, arranged in the stacked configuration within the interior volume of the gas storage vessel 100. In some embodiments, one or more pucks in the stack comprise the first sorbent component 102 modified with the second sorbent component 104, for example, where the first sorbent component 102 is functionalized, impregnated, doped, coated, or infused with the second sorbent component 104, as described herein.

It will be appreciated that while the first sorbent component 102 and the second sorbent component 104 are depicted as being located in different portions of the gas storage vessel 100 in FIG. 1, other configurations are possible, for example and without limitation, the second sorbent component being mixed with the first sorbent component so that both are located throughout the gas storage vessel, the second sorbent component being mixed into the first sorbent component such that the second sorbent component and the first sorbent component form a singular sorbent component, the first sorbent component being embedded with the second sorbent component, the first sorbent component being doped with the second sorbent component, the first sorbent component being impregnated with the second sorbent component, the first sorbent component being functionalized with the second sorbent component, or any combination thereof. In some embodiments, the first sorbent component may be mixed, embedded, doped, functionalized, or impregnated with the second sorbent such that a gradient of the second sorbent exists within the vessel. In some embodiments, the gradient, when present, decreases gradually in a direction from an upper portion 114 of the vessel 100 to a bottom portion 116 of the vessel 100.

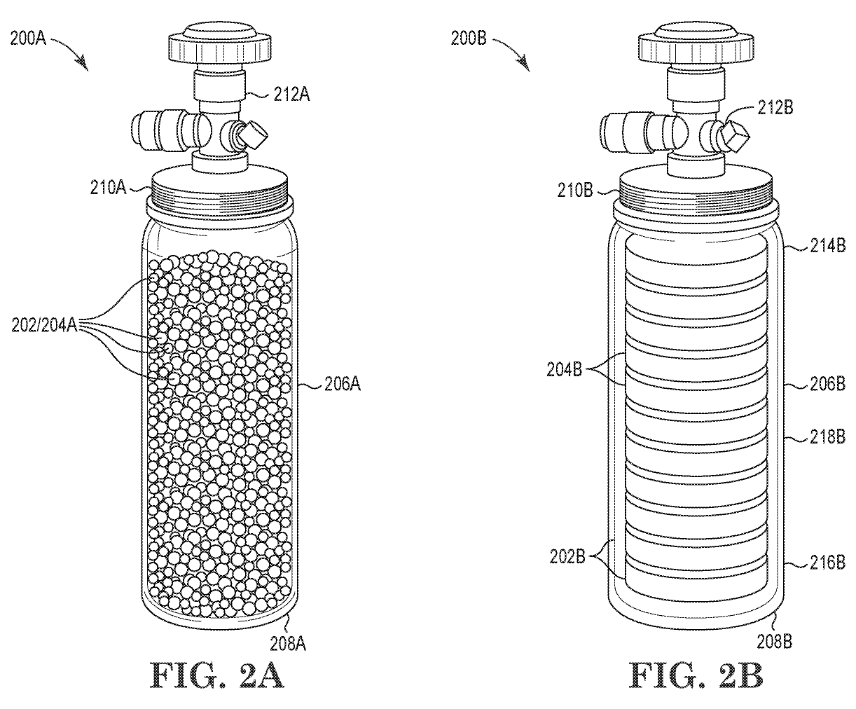

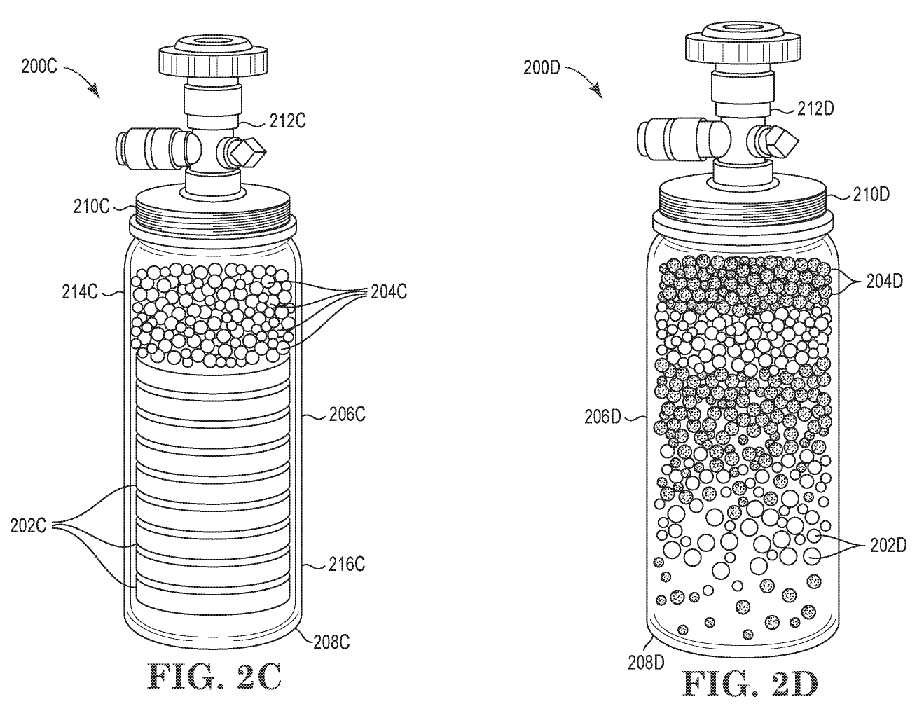

FIGS. 2A through 2D are schematic cross-sectional views of gas storage vessels illustrating various configurations of the sorbent material, according to some embodiments.

FIG. 2A is a schematic cross-sectional view of a gas storage vessel 200A containing a plurality of sorbent particles disposed within an interior volume of the gas storage vessel 200A. The gas storage vessel 200A comprises a sidewall 206A, a bottom wall 208A, and a neck collar 210A secured to the upper edges of the sidewall 206A. A valve assembly 212A is threadably engaged with the neck collar 210A. The sorbent material in the gas storage vessel 200A comprises a plurality of particles 202A comprising the first sorbent component modified with the second sorbent component 204A. The plurality of particles 202A comprising the first sorbent component can be embedded, functionalized, or impregnated with the second sorbent component 204A. In some embodiments, each of the particles 202A comprises the second sorbent component 204A at a substantially uniform loading throughout the interior volume of the gas storage vessel 200A. The modified particles 202A can be disposed as a packed bed within the interior volume of the gas storage vessel 200A. In some embodiments, the modified particles 202A comprise a pyrolyzed carbon or an activated pyrolyzed carbon functionalized, impregnated, or embedded with a metal halide, as described herein. In one embodiment, the modified particles 202A comprise a pyrolyzed carbon or an activated pyrolyzed carbon (first sorbent component) impregnated with an alkali metal halide such as, for example, potassium fluoride (second sorbent component).

FIG. 2B is a schematic cross-sectional view of a gas storage vessel 200B containing a sorbent material in the form of a plurality of monolithic pucks arranged in a stacked configuration within the interior volume of the gas storage vessel 200B. The gas storage vessel 200B comprises a sidewall 206B, a bottom wall 208B, and a neck collar 210B secured to the upper edges of the sidewall 206B. A valve assembly 212B is threadably engaged with the neck collar 210B. The plurality of pucks are stacked in contact with one another in a face-to-face relationship along a longitudinal axis of the gas storage vessel 200B. Each puck has a diameter closely proximate to the inner diameter of the gas storage vessel 200B, with minimal clearance between the peripheral edges of the pucks and the interior surface of the sidewall 206B. In some embodiments, the uppermost puck in the stack has a central passage to accommodate a filter and feed tube assembly extending downwardly from the valve assembly 212B.

In some embodiments, one or more pucks comprise the first sorbent component 202B, and one or more pucks comprise the second sorbent component 204B. In some embodiments, one or more pucks comprise the first sorbent component 202B modified (e.g., functionalized, impregnated, doped, coated, or embedded) with the second sorbent component 204B. In some embodiments, the second sorbent component 204B is present in a concentration gradient within the stack of pucks. For example, pucks located in an upper portion 214B of the gas storage vessel 200B may comprise a higher loading of the second sorbent component 204B (e.g., a higher weight percentage of the second sorbent component by functionalization, impregnation, doping, coating, or embedding) than pucks located in a lower portion 216B of the gas storage vessel 200B. In some embodiments, the concentration gradient decreases gradually from puck to puck in a direction from the upper portion 214B toward the lower portion 216B of the vessel 200B. In some embodiments, pucks in the lower portion 216B comprise only the first sorbent component 202B with no second sorbent component, while pucks in the upper portion 214B comprise the first sorbent component 202B modified with the second sorbent component 204B. In other embodiments, pucks in the lower portion 216B comprise only the first sorbent component 202B with no second sorbent component, while pucks in a middle portion 218B comprise the first sorbent component 202B modified with the second sorbent component 204B, and pucks in the upper portion 214B comprise only the second sorbent component 204B. Such a gradient positions a greater amount of the second sorbent component proximate to the valve assembly 212B for final-stage impurity sorption before the desorbed gas exits the gas storage vessel 200B.

In some embodiments, the sorbent material in the gas storage vessel 200B is arranged in a two-zone configuration. In some embodiments, pucks in an upper portion 214B of the gas storage vessel 200B comprise only the second sorbent component 204B, while pucks in a lower portion 216B of the gas storage vessel 200B comprise only the first sorbent component 202B. In some embodiments, the pucks comprising only the second sorbent component 204B occupy 5% to 50%, or any range or subrange between 5% to 50%, of the interior volume of the gas storage vessel 200B. For example, in some embodiments, the pucks comprising only the second sorbent component 204B occupy 5% to 45%, 5% to 40%, 5% to 35%, 5% to 33%, 5% to 30%, 5% to 25%, 5% to 20%, 5% to 15%, 5% to 10%, 10% to 50%, 15% to 50%, 20% to 50%, 25% to 50%, 30% to 50%, 33% to 50%, 35% to 50%, 40% to 50%, or 45% to 50% of the interior volume of the gas storage vessel 200B. In some embodiments, the remaining interior volume of the gas storage vessel 200B is occupied by pucks comprising only the first sorbent component 202B. For example, in some embodiments, pucks in at least the upper 50% of the gas storage vessel 200B comprise only the second sorbent component 204B, while pucks in the lower 50% of the gas storage vessel 200B comprise only the first sorbent component 202B. In other embodiments, pucks in at least the upper 33% of the gas storage vessel 200B comprise only the second sorbent component 204B, while pucks in the lower 67% of the gas storage vessel 200B comprise only the first sorbent component 202B. In still other embodiments, pucks in at least the upper 10% of the gas storage vessel 200B comprise only the second sorbent component 204B, while pucks in the lower 90% of the gas storage vessel 200B comprise only the first sorbent component 202B.

During dispensing, the second vapor can be desorbed under the impetus of a reduced pressure in flow circuitry external to the gas storage vessel 200B. In some embodiments, the gas storage vessel 200B may additionally or alternatively be subjected to heating to effect desorption of gas from the sorbent material.

FIG. 2C is a schematic cross-sectional view of a gas storage vessel 200C containing a plurality of monolithic sorbent pucks provided in combination with a plurality of sorbent particles within the interior volume of the gas storage vessel 200C. The gas storage vessel 200C comprises a sidewall 206C, a bottom wall 208C, and a neck collar 210C secured to the upper edges of the sidewall 206C. A valve assembly 212C is threadably engaged with the neck collar 210C. In some embodiments, a plurality of pucks of the first sorbent component 202C are stacked in the interior volume of the gas storage vessel 200C and a plurality of particles of the second sorbent component 204C are disposed on top of the stack of pucks, between the uppermost puck and the neck collar 210C. In some cases, the plurality of particles of the second sorbent component 204C can also be disposed in the interstitial spaces between and around the pucks.

In some embodiments, one or more of the pucks may additionally comprise the first sorbent component 202C modified with the second sorbent component 204C. In such embodiments, the particles of the second sorbent component 204C disposed on top of the stack of pucks are substantially 100% second sorbent component, and the pucks below comprise the first sorbent component 202C modified with a decreasing loading of the second sorbent component 204C in a direction from the upper portion 214C of the gas storage vessel 200C toward the lower portion 216C of the gas storage vessel 200C. For example, pucks nearest the particles of the second sorbent component 204C may comprise the first sorbent component 202C modified with a relatively higher weight percentage of the second sorbent component 204C, while pucks further from the particles may comprise the first sorbent component 202C modified with a relatively lower weight percentage of the second sorbent component 204C, or may comprise only the first sorbent component 202C with no second sorbent component. In this manner, a concentration gradient of the second sorbent component 204C exists within the gas storage vessel 200C, transitioning from the particles of the second sorbent component 204C at the top of the vessel, through pucks of decreasing second sorbent component loading, to pucks of the first sorbent component 202C alone at or near the lower portion 216C of the gas storage vessel 200C. In either embodiment described with respect to FIG. 2C, the concentration of the second sorbent component 204C is greatest in the upper portion 214C of the gas storage vessel 200C. Such a combined configuration, with both particulate and monolithic forms of the second sorbent component and an optional concentration gradient biased toward the upper portion 214C, provides multiple opportunities for impurity sorption as the desorbed gas flows toward the valve assembly 212C during a dispensing operation.

FIG. 2D is a schematic cross-sectional view of a gas storage vessel 200D containing a mixture of first sorbent component particles and second sorbent component particles distributed throughout the interior volume of the gas storage vessel 200D. The gas storage vessel 200D comprises a sidewall 206D, a bottom wall 208D, and a neck collar 210D secured to the upper edges of the sidewall 206D. A valve assembly 212D is threadably engaged with the neck collar 210D. The sorbent material in the gas storage vessel 200D comprises a plurality of first sorbent component particles 202D and a plurality of second sorbent component particles 204D. In some embodiments, the first sorbent component particles 202D and the second sorbent component particles 204D are uniformly mixed throughout the interior volume of the gas storage vessel 200D. In some embodiments, the first sorbent component particles 202D and the second sorbent component particles 204D are compositionally distinct from one another, such that the first sorbent component particles 202D are not modified with the second sorbent component. In some embodiments, the second sorbent component particles 204D are distributed in a concentration gradient within the gas storage vessel 200D, with a higher concentration of the second sorbent component particles 204D in an upper portion 214D of the gas storage vessel 200D than in a lower portion 216D of the gas storage vessel 200D. In some embodiments, the concentration gradient is achieved by layered filling of the gas storage vessel 200D with successive charges of particulate mixtures having differing ratios of the first sorbent component particles 202D to the second sorbent component particles 204D.

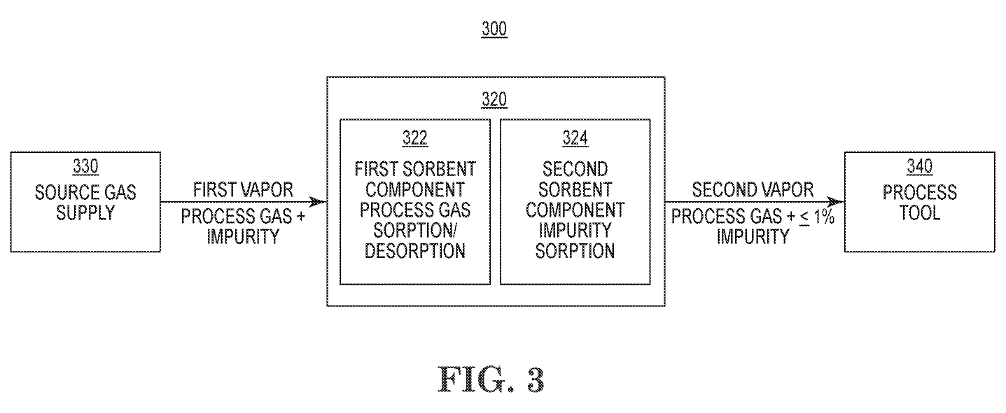

FIG. 3 is a system-level schematic diagram of a gas storage and delivery system 300, according to some embodiments. As shown in FIG. 3, the gas storage and delivery system 300 comprises a source gas supply 330, a gas storage vessel 320, and a process tool 340. The gas storage vessel 320 contains a sorbent material as described herein according to the various embodiments in an interior volume of the gas storage vessel 320. In some embodiments, the sorbent material comprises a first sorbent component 322 and a second sorbent component 324. In some embodiments, the first sorbent component 322 is configured to sorb and desorb a process gas. In some embodiments, the second sorbent component 324 is configured to sorb an impurity.

In operation, a first vapor is delivered from the source gas supply 330 to the gas storage vessel 320. In some embodiments, the first vapor comprises a process gas and up to 5% by volume of an impurity based on a total volume of the first vapor. The first vapor is received into the interior volume of the gas storage vessel 320, where the process gas is sorbed by the first sorbent component 322 and the impurity is sorbed by the second sorbent component 324. The process gas may be stored within gas storage vessel 320 at a remote location until it is required for use with a process tool such as process tool 340.

During delivery, the process gas is desorbed from the first sorbent component 322 as a second vapor. In some embodiments, the second vapor comprises the process gas and less than 1% by volume of the impurity based on a total volume of the second vapor. The impurity remains sorbed on the second sorbent component 324 and is not substantially desorbed during delivery of the second vapor. The second vapor is delivered from the gas storage vessel 320 to the process tool 340. In some embodiments, the second vapor is delivered from the gas storage vessel 320 to the process tool 340 through at least one of a pipe, a conduit, a cabinet, or any combination thereof.

In some embodiments, the gas storage vessel 320 operates at sub-atmospheric pressure. In some embodiments, the process tool 340 comprises a semiconductor manufacturing process tool. In some embodiments, the source gas supply 330 comprises a bulk gas source, a gas cylinder, or a gas generation system.

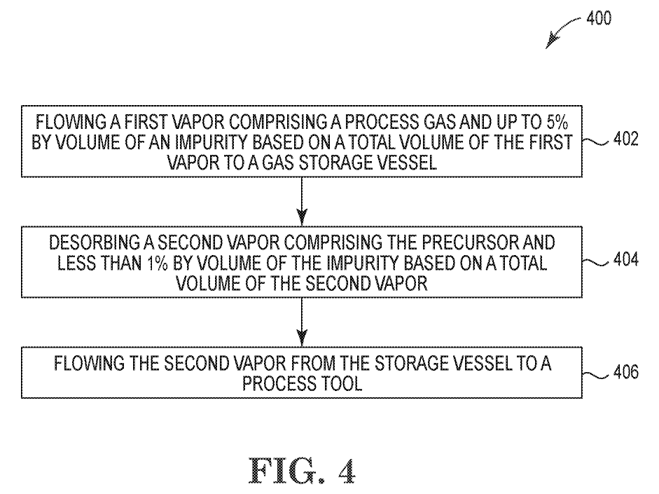

FIG. 4 is a flowchart of a method 400 of delivering a purified gas, according to some embodiments. As shown in FIG. 4, the method of delivering a purified gas 400 may comprise any one or more of the following steps: flowing 402 a first vapor comprising a process gas and up to 5% by volume of an impurity based on a total volume of the first vapor to a gas storage vessel; desorbing 404 a second vapor comprising the process gas and less than 5% by volume of the impurity based on a total volume of the second vapor; and flowing 406 the second vapor from the storage vessel to a process tool.

At step 402, in some embodiments, the method comprises flowing a first vapor comprising a process gas and up to 5% by volume of an impurity based on a total volume of the first vapor to a gas storage vessel. In some embodiments, the process gas comprises any one or more of the process gases disclosed herein. In some embodiments, the impurity comprises any one or more of the impurities disclosed herein. In some embodiments, the gas storage vessel comprises any one or more of the gas storage vessels disclosed herein.

In some embodiments, the flowing 402 comprises flowing the first vapor into the gas storage vessel. In some embodiments, the flowing 402 comprises pumping the first vapor into the gas storage vessel. In some embodiments, the flowing 402 comprises charging the gas storage vessel with the first vapor.

In some embodiments, the gas storage vessel comprises a sorbent material. In some embodiments, the sorbent material comprises any one or more of the sorbent materials disclosed herein. For example, in some embodiments, the sorbent material comprises a first sorbent component for sorbing and desorbing a process gas and a second sorbent component for selectively sorbing an impurity.

At step 404, in some embodiments, the method comprises desorbing a second vapor. In some embodiments, the second vapor can comprise any one or more of the second vapors disclosed herein. For example, in some embodiments, the second vapor comprises the process gas and less than 1% by volume of the impurity based on a total volume of the second vapor. In some embodiments, the second vapor comprises a purified gas.

In some embodiments, the desorbing 404 comprises selectively desorbing the process gas and not the impurity. For example, in some embodiments, the desorbing 404 comprises operating the gas storage vessel to desorb the maximum amount of process gas possible while desorbing as little impurity as possible. In some embodiments, the desorbing 404 comprises only desorbing the process gas. In some embodiments, the desorbing 404 comprises not desorbing the impurity. In some embodiments, the desorbing 404 comprises adjusting at least one of a pressure, a temperature, or any combination thereof, of the gas storage vessel.

In some embodiments, the desorbing 404 comprises adjusting the pressure of the gas storage vessel. In some embodiments, the pressure is a pressure of 3 Torr to 650 Torr, or any range or subrange between 3 Torr to 650 Torr. For example, in some embodiments, the pressure is a pressure of 3 Torr to 600 Torr, 3 Torr to 550 Torr, 3 Torr to 500 Torr, 3 Torr to 450 Torr, 3 Torr to 400 Torr, 3 Torr to 350 Torr, 3 Torr to 300 Torr, 3 Torr to 250 Torr, 3 Torr to 200 Torr, 3 Torr to 150 Torr, 3 Torr to 100 Torr, 3 Torr to 90 Torr, 3 Torr to 80 Torr, 3 Torr to 70 Torr, 3 Torr to 60 Torr, 3 Torr to 50 Torr, 3 Torr to 40 Torr, 3 Torr to 30 Torr, 3 Torr to 20 Torr, 3 Torr to 10 Torr, 3 Torr to 5 Torr, 5 Torr to 650 Torr, 10 Torr to 650 Torr, 20 Torr to 650 Torr, 30 Torr to 650 Torr, 40 Torr to 650 Torr, 50 Torr to 650 Torr, 60 Torr to 650 Torr, 70 Torr to 650 Torr, 80 Torr to 650 Torr, 90 Torr to 650 Torr, 100 Torr to 650 Torr, 150 Torr to 650 Torr, 200 Torr to 650 Torr, 250 Torr to 650 Torr, 300 Torr to 650 Torr, 350 Torr to 650 Torr, 400 Torr to 650 Torr, 450 Torr to 650 Torr, 500 Torr to 650 Torr, 550 Torr to 650 Torr, or 600 Torr to 650 Torr.

In some embodiments, the desorbing 404 comprises adjusting the temperature of the gas storage vessel. In some embodiments, the temperature is a temperature of 0 °C to 50 °C, or any range or subrange between 0 °C to 50 °C. For example, in some embodiments, the temperature is a temperature of 0 °C to 45 °C, 0 °C to 40 °C, 0 °C to 35 °C, 0 °C to 30 °C, 0 °C to 25 °C, 0 °C to 20 °C, 0 °C to 15 °C, 0 °C to 10 °C, 0 °C to 5 °C, 5 °C to 50 °C, 10 °C to 50 °C, 15 °C to 50 °C, 20 °C to 50 °C, 25 °C to 50 °C, 30 °C to 50 °C, 35 °C to 50 °C, 40 °C to 50 °C, or 45 °C to 50 °C. In some embodiments, the temperature is a temperature of 20 °C to 25 °C, or any range or subrange between 20 °C to 25 °C. For example, in some embodiments, the temperature is a temperature of 20 °C, 21 °C, 22 °C, 23 °C, 24 °C, or 25°C.

At step 406, in some embodiments, the method comprises flowing the second vapor from the gas storage vessel to a process tool. In some embodiments, the process tool comprises a process tool for semiconductor manufacture. In some embodiments, the flowing comprises flowing the second vapor from the gas storage vessel to a process tool using at least one of a pipe, a conduit, a cabinet, or any combination thereof. In some embodiments, the flowing 406 comprises delivering the second vapor from the gas storage vessel to a process tool.

### Example

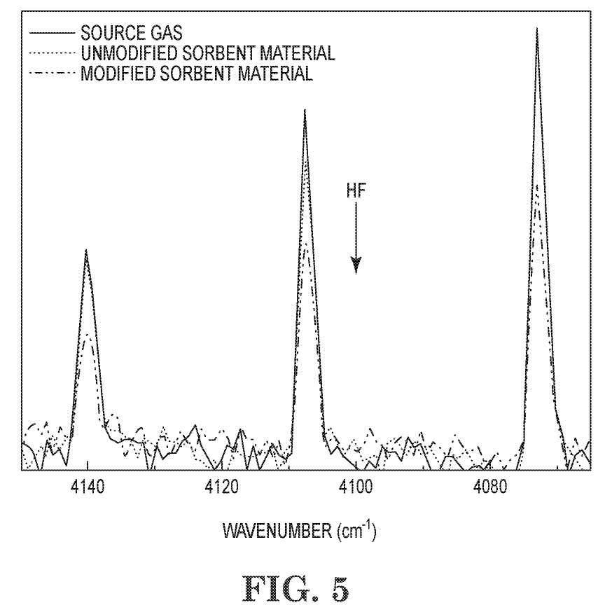

A source gas of GeF₄ was obtained. The amount of HF impurity in the source gas was measured. An unmodified sorbent material and a modified sorbent material were obtained. The unmodified sorbent material comprised an unmodified pyrolyzed carbon component. The modified sorbent material comprised a pyrolyzed carbon component modified with 0.07% by weight of a potassium fluoride based on a total weight of the modified sorbent material. The unmodified sorbent material and the modified sorbent material were each located in separate gas storage vessels. Each gas storage vessel was charged with the source gas. The pressures of the gas storage vessels were adjusted to desorb the gas from the vessels and the amount of HF impurity in the desorbed gas was measured. The gas desorbed from the unmodified sorbent material contained the same amount of HF impurity as the source gas. The gas desorbed from the modified sorbent material had 30% less HF impurity than the source gas. FIG. 5 shows the FTIR spectra peaks correlating to the HF impurity in the source gas, the gas desorbed from the unmodified sorbent material, and the gas desorbed from the modified sorbent material.

The selective retention of HF by the modified sorbent material is consistent with dipole-dipole interactions between HF, which has a permanent dipole moment, and the potassium fluoride on the modified sorbent material surface. GeF₄, which lacks a permanent dipole moment, is not preferentially retained by the potassium fluoride and desorbs with the second vapor.

### ASPECTS

Various Aspects are described below. It is to be understood that any one or more of the features recited in the following Aspect(s) can be combined with any one or more other Aspect(s).

Aspect 1 is an assembly comprising a vessel and a sorbent material contained in an interior volume of the vessel, wherein the sorbent material comprises a first sorbent component for sorbing and desorbing a process gas and a second sorbent component for selectively sorbing an impurity, wherein, under operating conditions, the sorbent material sorbs a first vapor comprising the process gas and up to 5% by volume of the impurity based on a total volume of the first vapor and desorbs a second vapor comprising the process gas and less than 1% by volume of the impurity based on a total volume of the second vapor.

Aspect 2 is the assembly of Aspect 1, wherein the first sorbent component comprises at least one of a pyrolyzed carbon, an activated pyrolyzed carbon, or any combination thereof.

Aspect 3 is the assembly of any of Aspects 1-2, wherein the second sorbent component comprises at least one of an alkali metal, an alkaline earth metal, a transition metal, a molecular sieve, an alumina, a pyrolyzed carbon, an activated pyrolyzed carbon, or any combination thereof.

Aspect 4 is the assembly of any of Aspects 1-3, wherein the sorbent material comprises 40% to 99.999% by weight of the first sorbent component based on a total weight of the sorbent material and 0.001% to 60% by weight of the second sorbent component based on the total weight of the sorbent material.

Aspect 5 is the assembly of any of Aspects 1-4, wherein the process gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorus pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydride, a halide compound, an organometallic compound, or any combination thereof.

Aspect 6 is the assembly of any of Aspects 1-5, wherein, under operating conditions, the sorbent material sorbs a first vapor comprising the process gas and up to 5% by volume of the impurity based on a total volume of the first vapor and desorbs a second vapor comprising the process gas and less than 0.5% by volume of the impurity based on a total volume of the second vapor.

Aspect 7 is the assembly of any of Aspects 1-6, wherein the second sorbent component comprises a plurality of particles.

Aspect 8 is the assembly of any of Aspects 1-7, wherein the first sorbent component is modified with the second sorbent component.

Aspect 9 is a sorbent material comprising a first sorbent component for sorbing and desorbing a process gas and a second sorbent component for selectively sorbing an impurity, wherein, when contained in a gas storage vessel under operating conditions, the sorbent material sorbs a first vapor comprising the process gas and up to 5% by volume of the impurity based on a total volume of the first vapor and desorbs a second vapor comprising the process gas and less than 1% by volume of the impurity based on a total volume of the second vapor.

Aspect 10 is the sorbent material of Aspect 9, wherein the first sorbent component comprises at least one of a pyrolyzed carbon, an activated pyrolyzed carbon, or any combination thereof.

Aspect 11 is the sorbent material of any of Aspects 9-10, wherein the second sorbent component comprises at least one of an alkali metal, an alkaline earth metal, a transition metal, a molecular sieve, an alumina, a pyrolyzed carbon, an activated pyrolyzed carbon, or any combination thereof.

Aspect 12 is the sorbent material of any of Aspects 9-11, comprising 40% to 99.999% by weight of the first sorbent component based on a total weight of the sorbent material and 0.001% to 60% by weight of the second sorbent component based on the total weight of the sorbent material.

Aspect 13 is the sorbent material of any of Aspects 9-12, wherein the process gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorus pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydride, a halide compound, an organometallic compound, or any combination thereof.

Aspect 14 is the sorbent material of any of Aspects 9-13, wherein, when contained in a gas storage vessel under operating conditions, the sorbent material sorbs a first vapor comprising the process gas and up to 5% by volume of the impurity based on a total volume of the first vapor and desorbs a second vapor comprising the process gas and less than 0.5% by volume of the impurity based on a total volume of the second vapor.

Aspect 15 is the sorbent material of any of Aspects 9-14, wherein the second sorbent component comprises a plurality of particles.

Aspect 16 is the sorbent material of any of Aspects 9-15, wherein the first sorbent component is modified with the second sorbent component.

Aspect 17 is a method comprising delivering a first vapor comprising a process gas and up to 5% by volume of an impurity based on a total volume of the first vapor to a gas storage vessel, wherein the gas storage vessel comprises a sorbent material, wherein the sorbent material comprises a first sorbent component for sorbing and desorbing the process gas and a second sorbent component for selectively sorbing the impurity, wherein, under operating conditions, the sorbent material is configured to desorb a second vapor comprising the process gas and less than 1% by volume of the impurity based on a total volume of the second vapor.

Aspect 18 is the method of Aspect 17, wherein the first sorbent component comprises at least one of a pyrolyzed carbon, an activated pyrolyzed carbon, or any combination thereof.

Aspect 19 is the method of any of Aspects 17-18, wherein the second sorbent component comprises at least one of an alkali metal, an alkaline earth metal, a transition metal, a molecular sieve, an alumina, a pyrolyzed carbon, an activated pyrolyzed carbon, or any combination thereof.

Aspect 20 is the method of any of Aspects 17-19, wherein the sorbent material comprises 40% to 99.999% by weight of the first sorbent component based on a total weight of the sorbent material and 0.001% to 60% by weight of the second sorbent component based on the total weight of the sorbent material.

Aspect 21 is the method of any of Aspects 17-20, further comprising desorbing the second vapor comprising the process gas and less than 1% by volume of the impurity based on a total volume of the second vapor.

Aspect 22 is the method of Aspect 21, further comprising delivering the second vapor to a process tool.

The foregoing detailed description has been presented for purposes of illustration and description. It is not intended to be exhaustive or to limit the present disclosure to the precise forms disclosed. Many modifications and variations are possible in light of the above teachings. The described embodiments were chosen to best explain the principles of the disclosed technology and its practical application, to thereby enable others skilled in the art to best utilize the disclosed technology in various embodiments and with various modifications as are suited to the particular use contemplated. The scope of the disclosure is to be defined by the claims appended hereto.

What is claimed is:

1. An assembly comprising:
a vessel; and
a sorbent material contained in an interior volume of the vessel,
wherein the sorbent material comprises:
a first sorbent component for sorbing and desorbing a process gas; and
a second sorbent component for selectively sorbing an impurity;
wherein, under operating conditions, the sorbent material:
sorbs a first vapor comprising the process gas and up to 5% by volume of the impurity based on a total volume of the first vapor; and
desorbs a second vapor comprising the process gas and less than 1% by volume of the impurity based on a total volume of the second vapor.

2. The assembly of claim 1, wherein the first sorbent component comprises at least one of a pyrolyzed carbon, an activated pyrolyzed carbon, or any combination thereof.

3. The assembly of claim 1, wherein the second sorbent component comprises at least one of an alkali metal, an alkaline earth metal, a transition metal, a molecular sieve, an alumina, a pyrolyzed carbon, an activated pyrolyzed carbon, or any combination thereof.

4. The assembly of claim 1, wherein the sorbent material comprises:
40% to 99.999% by weight of the first sorbent component based on a total weight of the sorbent material; and
40.001% to 60% by weight of the second sorbent component based on the total weight of the sorbent material.

5. The assembly of claim 1, wherein the process gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorus pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydride, a halide compound, an organometallic compound, or any combination thereof.

6. The assembly of claim 1, wherein, under operating conditions, the sorbent material:
sorbs a first vapor comprising the process gas and up to 5% by volume of the impurity based on a total volume of the first vapor; and
desorbs a second vapor comprising the process gas and less than 0.5% by volume of the impurity based on a total volume of the second vapor.

7. The assembly of claim 1, wherein the second sorbent component comprises a plurality of particles.

8. The assembly of claim 1, wherein the first sorbent component is modified with the second sorbent component.

9. A sorbent material comprising:
a first sorbent component for sorbing and desorbing a process gas; and
a second sorbent component for selectively sorbing an impurity,
wherein, when contained in a gas storage vessel under operating conditions, the sorbent material:
sorbs a first vapor comprising the process gas and up to 5% by volume of the impurity based on a total volume of the first vapor; and
desorbs a second vapor comprising the process gas and less than 1% by volume of the impurity based on a total volume of the second vapor.

10. The sorbent material of claim 9, wherein the first sorbent component comprises at least one of a pyrolyzed carbon, an activated pyrolyzed carbon, or any combination thereof.

11. The sorbent material of claim 9, wherein the second sorbent component comprises at least one of an alkali metal, an alkaline earth metal, a transition metal, a molecular sieve, an alumina, a pyrolyzed carbon, an activated pyrolyzed carbon, or any combination thereof.

12. The sorbent material of claim 9, comprising:
40% to 99.999% by weight of the first sorbent component based on a total weight of the sorbent material; and
120.001% to 60% by weight of the second sorbent component based on the total weight of the sorbent material.

13. The sorbent material of claim 9, wherein the process gas comprises at least one of an arsine, a phosphine, a phosgene, a diborane, a boron trifluoride, an enriched ¹¹boron trifluoride, a germanium tetrafluoride, an enriched ⁷²germanium tetrafluoride, a phosphorus trifluoride, a phosphorus pentafluoride, a silicon tetrafluoride, a germane, a silane, an ammonia, a stibine, a hydrogen sulfide, a hydrogen selenide, a hydrogen telluride, a nitrous oxide, a hydrogen cyanide, an ethylene oxide, a deuterated hydride, a halide compound, an organometallic compound, or any combination thereof.

14. The sorbent material of claim 9, wherein, when contained in a gas storage vessel under operating conditions, the sorbent material:
sorbs a first vapor comprising the process gas and up to 5% by volume of the impurity based on a total volume of the first vapor; and
desorbs a second vapor comprising the process gas and less than 0.5% by volume of the impurity based on a total volume of the second vapor.

15. The sorbent material of claim 9, wherein the second sorbent component comprises a plurality of particles.

16. The sorbent material of claim 9, wherein the first sorbent component is modified with the second sorbent component.

17. A method comprising:
delivering a first vapor comprising a process gas and up to 5% by volume of an impurity based on a total volume of the first vapor to a gas storage vessel,
wherein the gas storage vessel comprises a sorbent material,
wherein the sorbent material comprises:
a first sorbent component for sorbing and desorbing the process gas; and
a second sorbent component for selectively sorbing the impurity;
wherein, under operating conditions, the sorbent material is configured to desorb a second vapor comprising the process gas and less than 1% by volume of the impurity based on a total volume of the second vapor.

18. The method of claim 17, wherein the first sorbent component comprises at least one of a pyrolyzed carbon, an activated pyrolyzed carbon, or any combination thereof.

19. The method of claim 17, wherein the second sorbent component comprises at least one of an alkali metal, an alkaline earth metal, a transition metal, a molecular sieve, an alumina, a pyrolyzed carbon, an activated pyrolyzed carbon, or any combination thereof.

20. The method of claim 17, wherein the sorbent material comprises:
40% to 99.999% by weight of the first sorbent component based on a total weight of the sorbent material; and
200.001% to 60% by weight of the second sorbent component based on the total weight of the sorbent material.

21. The method of claim 17, further comprising desorbing the second vapor comprising the process gas and less than 1% by volume of the impurity based on a total volume of the second vapor.

22. The method of claim 21, further comprising delivering the second vapor to a process tool.
